(19) United States
(12) Patent Application Publication
(10) Pub. No.: US 2026/0098135 A1
(43) Pub. Date: Apr. 9, 2026

(54) DOUBLE LAYER TUBE AND METHOD FOR PRODUCING THE SAME

(71) Applicant: DAIKIN INDUSTRIES, LTD., Osaka (JP)

(72) Inventors: Hitoshi IMAMURA, Osaka (JP); Takahisa AOYAMA, Osaka (JP); Hiroyuki HAMADA, Osaka (JP); Manabu FUJISAWA, Osaka (JP)

(73) Assignee: DAIKIN INDUSTRIES, LTD., Osaka (JP)

(21) Appl. No.: 19/416,149

(22) Filed: Dec. 11, 2025

Related U.S. Application Data
(63) Continuation of application No. PCT/JP2024/021409, filed on Jun. 12, 2024.

(30) Foreign Application Priority Data
Jun. 13, 2023 (JP) 2023-097304

(51) Int. Cl. C08J 7/04; B29C 71/02; B32B 1/08; B32B 27/08; B32B 27/30; B32B 27/32

(52) U.S. Cl. CPC C08J 7/04; B32B 1/08; B32B 27/08; B32B 27/304; B32B 27/322; C08J 7/08; B32B 2250/02; B32B 2250/246; B32B 2323/04; B32B 2329/00; C08J 2327/12; C08J 2335/08

(57) ABSTRACT

Provided is a double layer tube including an inner layer (A) and an outer layer (B) disposed directly on the inner layer (A), wherein the inner layer (A) comprises a copolymer (a) that comprises tetrafluoroethylene unit and perfluoro(propyl vinyl ether) unit, and the outer layer (B) comprises a polymer (b) that comprises at least chlorotrifluoroethylene unit; wherein the copolymer (a) has a rate of decrease in weight of 0.05 mass % or less after heat treatment at 380° C. for 1 hour; and wherein a ratio between a thickness of the inner layer (A) and a thickness of the outer layer (B), ((A)/(B)), is 30.0/70.0 to 67.0/33.0.

### CROSS-REFERENCE TO RELATED APPLICATIONS

This application is a Rule 53 (b) Continuation of International Application No. PCT/JP2024/021409 filed Jun. 12, 2024, which claims priority based on Japanese Patent Application No. 2023-097304 filed Jun. 13, 2023, the respective disclosures of which are incorporated herein by reference in their entirety.

### TECHNICAL FIELD

The present disclosure relates to a double layer tube and a production method thereof.

### BACKGROUND ART

Patent Document 1 discloses a chlorotrifluoroethylene copolymer-containing laminate having a layer (A) of tetrafluoroethylene/perfluorovinyl ether copolymer and/or tetrafluoroethylene/hexafluoropropylene copolymer and a layer (B) of chlorotrifluoroethylene copolymer, wherein the layer (A) and the layer (B) are stacked by coextrusion forming under conditions with channel temperatures in a multilayer die before contact between a material (a) of the layer (A) and a material (b) of the layer (B) being controlled to 300 to 400° C. for a channel (pa) where the material (a) flows and 250 to 350° C. for a channel (pb) where the material (b) flows.

### RELATED ART

### Patent Documents

Patent Document 1: International Publication No. WO 2006/095857

### SUMMARY

According to the present disclosure, provided is a double layer tube comprising an inner layer (A) and an outer layer (B) disposed directly on the inner layer (A), wherein the inner layer (A) comprises a copolymer (a) that comprises tetrafluoroethylene unit and perfluoro (propyl vinyl ether) unit, and the outer layer (B) contains a polymer (b) that comprises at least chlorotrifluoroethylene unit; wherein the copolymer (a) has a rate of decrease in weight of 0.05 mass % or less after heat treatment at 380° C. for 1 hour; and wherein the ratio between a thickness of the inner layer (A) and a thickness of the outer layer (B), ((A)/(B)), is 30.0/70.0 to 67.0/33.0.

### Effects

According to the present disclosure, a double layer tube capable of maintaining low permeability of hydrochloric acid even when left standing in warm water for a long period with hydrochloric acid aqueous solution encapsulated therein can be provided.

### BRIEF DESCRIPTION OF DRAWINGS

FIG. 1 is an image showing a cross section of a tube made in Comparative Example 1.

FIG. 2 is an image showing a cross section of a tube made in Comparative Example 2.

FIG. 3 is an image showing a cross section of a tube made in Example 1.

FIG. 4 is a schematic view showing experimental equipment for use in measuring 35 mass % hydrochloric acid permeation coefficient of a double layer tube.

### DESCRIPTION OF EMBODIMENTS

Specific embodiments of the present disclosure are described in detail as follows, though the present disclosure is not limited to the following embodiments.

The present disclosure relates to a double layer tube including an inner layer (A) and an outer layer (B).

Patent Document 1 discloses that a fluorine-containing resin tube such as PFA resin tube conventionally widely used for transporting a chemical solution typified by hydrochloric acid, hydrofluoric acid, nitric acid or the like used in a semiconductor plant or a liquid crystal plant is bleached and deteriorated by itself due to permeation of the chemical solution from the tube, resulting in increase of the acid concentration in the plant which causes problems such as corrosion of equipment and environmental pollution, and one having a small chemical solution permeability coefficient from the tube is desired in order to improve the problems.

Accordingly, Patent Document 1 discloses that a layer (A) made of tetrafluoroethylene/perfluorovinyl ether copolymer and/or tetrafluoroethylene/hexafluoropropylene copolymer and a layer (B) made of chlorotrifluoroethylene copolymer are stacked through coextrusion forming under conditions with channel temperatures in specific ranges described as follows to manufacture a laminate, and the resulting laminate has a small 35 mass % hydrochloric acid permeation coefficient at 25° C.

However, it has been found that although a conventional tube hardly causes permeation of hydrochloric acid in water at low temperature, in the case where the tube is left standing in warm water for a long period, cracks in the inner layer may occur, and in the case where the tube is left standing in water at normal temperature for a long period, hydrochloric acid permeation cannot be sufficiently suppressed.

Through extensive study of means for solving the problem, it has been found that by forming the inner layer of a double layer tube from a copolymer that contains a tetrafluoroethylene unit and a perfluoro (propyl viny ether) unit, with a rate of decrease in weight after heat treatment at 380° C. for 1 hour appropriately adjusted, and adjusting the thicknesses of the inner layer and the outer layer in an extremely limited ranges, the resulting double layer tube with hydrochloric acid aqueous solution encapsulated therein hardly generate cracks in the inner layer even in the case where the tube is left standing in warm water for a long period, and low permeability of hydrochloric acid can be maintained even in the case where the tube is left standing in water at normal temperature for a long period. The double layer tube of the present disclosure has been completed based on the expertise.

In the following, the structure of the double layer tube of the present disclosure is described in more detail.

The double layer tube of the present disclosure includes an inner layer (A) and an outer layer (B), wherein the inner layer (A) contains a copolymer (a) that contains a tetrafluoroethylene (TFE) unit and a perfluoro (propyl viny ether) (PPVE) unit, and the outer layer (B) contains a polymer (b) that contains at least a chlorotrifluoroethylene (CTFE) unit.

<Inner layer (A)>

The inner layer (A) contains a copolymer (a) that contains a TFE unit and a PPVE unit. The copolymer (a) has a specific rate of decrease in weight.

The rate of decrease in weight of the copolymer (a) is 0.05 mass % or less, and preferably 0.01 mass % or more.

The rate of decrease in weight of the copolymer (a) may be reduced to 0.05 mass % or less by an appropriate heat treatment of the copolymer (a) as described below.

The rate of decrease in weight of the polymer (a), may be calculated from the weight before heat treatment of the copolymer (a) at 380° C. for 1 hour and the weight after heating, according to the following formula.

Rate of decrease in weight (mass %)=[(Weight before heating)−(Weight after heating)]/(Weight before heating)×100

It is presumed that a copolymer having a low rate of decrease in weight after heat treatment at 380° C. for 1 hour contains almost no high-temperature volatile substance having a molecular weight of 3,000 or less. There is a possibility that the high-temperature volatile substance having a molecular weight of 3,000 or less is present in an amorphous state in a formed article of the copolymer (a) in a crystalline state, and forms a fine amorphous phase having a low density. There is a possibility that hydrochloric acid flowing inside the double layer tube dwells in the phase to cause thermal expansion stress resulting from the heat of association between an acid molecule and a water molecule, which causes cracks or insufficient suppression of hydrochloric acid permeation even without occurrence of cracks. It is presumed that forming the inner layer (A) from the copolymer (a) having a rate of decrease in weight of 0.05 mass % or less suppresses formation of an amorphous phase having a low density, so that occurrence of microcracks in the inner layer (A) is suppressed, resulting in maintaining excellent low hydrochloric acid permeability of the double layer tube.

Since the occurrence of cracks in the inner layer may be further suppressed and the hydrochloric acid permeation may be further suppressed while maintaining the excellent moldability of the copolymer (a), the zero shear viscosity of the copolymer (a) is preferably 2.00×10⁴ Pa·S or more, more preferably 2.50×10⁴ Pa·S or more, still more preferably 3.00×10⁴ Pa·S or more, and preferably 10.00×10⁴ Pa·S or less, more preferably 8.00×10⁴ Pa·S or less, still more preferably 5.00×10⁴ Pa·S or less.

The zero shear viscosity of the copolymer (a) may be adjusted by regulating the melt flow rate and the content of PPVE unit of the copolymer (a), and in parallel by regulating the amount of polymerization initiator, the amount of chain transfer agent, the pressure of polymerization, the time of polymerization in production and the like of the copolymer (a).

The zero shear viscosity of the copolymer (a) is the viscosity obtained at 340° C. for a frequency of 0.1 rad/s in melt viscoelasticity measurement of the copolymer (a). The zero shear viscosity may be measured using a melt viscoelasticity measurement apparatus.

Since the occurrence of cracks in the inner layer may be further suppressed and hydrochloric acid permeation may be further suppressed, the MIT value of the copolymer (a) is preferably 2,600,000 times or more, more preferably 10,000,000 times or less, and still more preferably 5,000,000 times or less.

The MIT value of the copolymer (a) may be adjusted by regulating the melt flow rate and the content of the PPVE unit of the copolymer (a).

The MIT value of the copolymer (a) may be determined by preparing a test piece of the copolymer (a) having a width of 12.7 mm, a length of 90 mm, and a thickness of 0.20 to 0.25 mm by compression molding, and bending the test piece under conditions with a load of 1.25 kg, each of right and left folding angles of 135 degrees, and number of times of folding of 175/minute so as to measure the times until the test piece is cut off (MIT value).

The copolymer (a) contains a TFE unit and a PPVE unit.

Since the occurrence of cracks in the inner layer may be further suppressed and hydrochloric acid permeation may be further suppressed, the content of the PPVE unit in the copolymer (a) relative to whole of the monomer units is preferably 4.0 to 6.5 mass %, more preferably 4.5 mass % or more, still more preferably 5.0 mass % or more, and particularly preferably 5.5 mass % or more.

The content of the TFE unit of the copolymer (a) relative to the whole monomer units is preferably 93.5 to 96.0 mass %, more preferably 95.5 mass % or less, still more preferably 95.0 mass % or less, and particularly preferably 94.5 mass % or less.

The copolymer (a) may contain a monomer unit derived from a monomer copolymerizable with TFE and PPVE.

Examples of the monomer copolymerizable with TFE and PPVE include hexafluoropropylene (HFP), a vinyl monomer represented by CZ³Z⁴═CZ⁵(CF₂)ₙZ⁶, (wherein Z³, Z⁴ and Z⁵ are the same or different, and represent H or F, Z⁶ represents H, F or Cl, and n represents an integer of 2 to 10), and an alkyl perfluorovinyl ether derivative represented by CF₂═CF—OCH₂—Rf⁷, (wherein Rf⁷ represents a perfluoroalkyl group having 1 to 5 carbon atoms). In particular, HFP is preferred.

The content of monomer units derived from the monomers copolymerizable with TFE and PPVE is preferably 0 to 1.5 mass %, more preferably 0.5 mass % or less, and still more preferably 0.1 mass % or less.

As the copolymer (a), since the occurrence of cracks in the inner layer may be further suppressed and hydrochloric acid permeation may be further suppressed, at least one selected from the group consisting of a copolymer made only from TFE unit and PPVE unit and a TFE/HFP/PPVE copolymer is preferred, and a copolymer made only from TFE unit and PPVE unit is more preferable.

In the present disclosure, the content of each of the monomer units in the copolymer is measured by the ¹⁹F-NMR method.

Since the occurrence of cracks in the inner layer may be further suppressed and hydrochloric acid permeation may be further suppressed, the melting point of the copolymer (a) is preferably 295 to 308° C.

In the present disclosure, the melting point of the copolymer (a) is the temperature corresponding to the maximum value in the heat-of-fusion curve when the temperature is raised (2nd run) at a rate of 10° C./min using a differential scanning calorimeter [DSC].

It is preferable that the copolymer (a) be a melt-fabricable fluororesin. In the present disclosure, melt-fabricability means that a polymer can be melted and processed using a conventional processing device such as extruder and injection molding machine. Accordingly, the melt-fabricable fluororesin usually has a melt flow rate of 0.01 to 500 g/10 min measured by the measurement method described as follows.

Since the occurrence of cracks in the inner layer may be further suppressed and hydrochloric acid permeation may be further suppressed, the melt flow rate (MFR) of the copolymer (a) is preferably 10.0 g/10 min or less, more preferably 5.0 g/10 min or less, still more preferably 3.0 g/10 min or less, and preferably 0.01 g/10 min or more, more preferably 0.1 g/10 min or more, still more preferably 1.0 g/10 min or more.

The MFR of the copolymer (a) is measured in accordance with ASTM D1238, using a die having a diameter of 2.1 mm and a length of 8 mm, under a load of 5 kg at 372° C.

The number of functional groups of the copolymer (a) per 10⁶ carbon atoms may be 500 or less, preferably 300 or less, more preferably 200 or less, still more preferably 100 or less, furthermore preferably 50 or less, and particularly preferably 10 or less.

The functional groups are a functional group present at an end of the main chain or an end of the side chain, and a functional group present in the main chain or the side chain of the copolymer. As the functional group, at least one selected from the group consisting of —CF═CF₂, —CF₂H, —COF, —COOH, —COOCH₃, —CONH₂ and —CH₂OH is preferred.

For identification of the type of functional groups and measurement of the number of functional groups, infrared spectroscopy may be used.

Specifically, the number of functional groups is measured by the following method. First, the copolymer is melted at 340 to 350° C. for 30 minutes, and compression-molded to make a film having a thickness of 0.05 to 0.25 mm. The film is analyzed by Fourier transform infrared spectroscopy to obtain an infrared absorption spectrum of the copolymer, and a differential spectrum is then obtained using a base spectrum for absence of functional group resulting from complete fluorination. From the absorption peak of a specific functional group emerging in the differential spectrum, the number of functional groups N per 1×10⁶ carbon atoms in the copolymer is calculated according to the following formula (A).

$$N = I \times K / t \qquad ( A )$$

I: absorbance
K: correction factor
T: thickness of film (mm)

For reference sake, the absorption frequencies, molar extinction coefficients, and correction factors of the functional groups in the present disclosure are shown in Table 1. The molar extinction coefficients have been determined from FT-IR measurement data of low-molecular weight model compounds.

TABLE 1

| | | Molar | | |
|---|---|---|---|---|
| | Absorption | Extinction | | |
| | Frequency | Coefficient | Correction | |
| Functional Group | (cm⁻¹) | (l/cm/mol) | Factor | Model Compound |
| —COF | 1883 | 600 | 388 | C₇F₁₅COF |
| —COOH free | 1815 | 530 | 439 | H(CF₂)₆COOH |
| —COOH bonded | 1779 | 530 | 439 | H(CF₂)₆COOH |
| —COOCH₃ | 1795 | 680 | 342 | C₇F₁₅COOCH₃ |
| —CONH₂ | 3436 | 506 | 460 | C₇H₁₅CONH₂ |
| —CH₂OH₂, —OH | 3648 | 104 | 2236 | C₇H₁₅CH₂OH |
| —CF₂H | 3020 | 8.8 | 26485 | H(CF₂CF₂)₃CH₂OH |
| —CF═CF₂ | 1795 | 635 | 366 | CF₂═CF₂ |

The absorption frequencies of —CH₂CF₂H, —CH₂COF, —CH₂COOH, —CH₂COOCH₃, and —CH₂CONH₂ are lower than the absorption frequencies of —CF₂H, —COF, —COOH free and —COOH bonded, —COOCH₃, and —CONH₂ by several tens of Kaiser (cm⁻¹) each of which shown in the table.

Accordingly, for example, the number of —COF functional groups is the sum of the number of functional groups obtained from the absorption peak at an absorption frequency of 1,883 cm⁻¹ arising from —CF₂COF and the number of functional groups obtained from the absorption peak at an absorption frequency of 1,840 cm⁻¹ arising from —CH₂COF.

The number of functional groups may be the total number of —CF═CF₂, —CF₂H, —COF, —COOH, —COOCH₃, —CONH₂, and —CH₂OH.

A functional group is introduced into the copolymer, for example, by a chain transfer agent or a polymerization initiator used in production of the copolymer. For example, in the case of using an alcohol as chain transfer agent or using a peroxide having a —CH₂OH structure as a polymerization initiator, —CH₂OH is introduced at an end of the main chain of the copolymer. Alternatively, through polymerization of a monomer having a functional group, the functional group is introduced at an end of the side chain of the copolymer.

The copolymer having such a functional group may be subjected to fluorination treatment to obtain a copolymer having a specified number of functional groups in the range described above. In other words, the copolymer (a) may be subjected to fluorination treatment. Alternatively, the copolymer (a) may have a —CF₃ terminal group.

To the inner layer (A), various additives such as a filler having electric conductivity, a stabilizer such as thermal stabilizer, a reinforcing agent, a filler, a UV absorber and a pigment may be added.

<Outer layer (B)>

The outer layer (B) contains a polymer (b) that contains at least a CTFE unit.

As the polymer (b), since the occurrence of cracks in the inner layer may be further suppressed and hydrochloric acid permeation may be further suppressed, at least one selected from the group consisting of polychlorotrifluoroethylene [PCTFE] and a CTFE copolymer is preferred, at least one selected from the group consisting of PCTFE, a CTFE/TFE copolymer, and an ethylene/CTFE copolymer is more preferred, and a CTFE/TFE copolymer is still more preferred.

As the polymer (b), a CTFE copolymer is preferred. As the CTFE copolymer, a copolymer containing a CTFE unit and a unit derived from at least one monomer selected from the group consisting of TFE, HFP, PAVE, vinylidene fluoride (VdF), vinyl fluoride, hexafluoro isobutene, a monomer represented by the formula: CH₂═CX¹(CF₂)ₙX² (wherein X¹ is H or F, X² is H, F or Cl, and n is an integer of 1 to 10), ethylene, propylene, 1-butene, 2-butene, vinyl chloride, and vinylidene chloride, is preferred.

As the CTFE copolymer, at least one selected from the group consisting of an ethylene/CTFE copolymer, and a copolymer containing a CTFE unit and a unit derived from at least one monomer selected from the group consisting of TFE, HFP and PAVE, is more preferred.

The ethylene/CTFE copolymer (ECTFE) is a copolymer containing an ethylene unit and a CTFE unit, and relative to the total of ethylene units and CTFE units, the ethylene unit content is preferably 46 to 52 mol % and the CTFE unit content is preferably 54 to 48 mol %. The ECTFE may be a two-dimensional copolymer containing ethylene units and CTFE units only, or one further containing a polymerization unit based on a monomer copolymerizable with ethylene and CTFE (for example, a perfluoro (alkyl vinyl ether) (PAVE) derivative).

The content of the polymerization unit based on a monomer copolymerizable with ethylene and CTFE is preferably 0.01 to 5 mol % relative to total of the ethylene unit, the CTFE unit and the polymerization unit based on the copolymerizable monomer.

The MFR of ECTFE is preferably 0.01 to 100 g/10 min. The measurement of the MFR of ECTFE is performed at a temperature of 230° C. under a load of 2.16 kg.

As the polymer (b), since the occurrence of cracks in the inner layer may be further suppressed, and hydrochloric acid permeation may be further suppressed, one containing a CTFE unit, a TFE unit and a monomer (α) unit derived from a monomer (α) copolymerizable with the CTFE unit and the TFE unit is particularly preferred.

The monomer (α) is not limited as long as it is a monomer copolymerizable with CTFE and TFE, and examples thereof include ethylene, VdF, perfluoro (alkyl viny ether) [PAVE] represented by CF₂═CF—ORf¹ (wherein Rf¹ is a perfluoroalkyl group having 1 to 8 carbon atoms), a vinyl monomer represented by the formula: CX³X⁴═CX⁵(CF₂)ₙX⁶ (wherein X³, X⁴ and X⁵ are the same or different, being a hydrogen atom or a fluorine atom, X⁶ is a hydrogen atom, a fluorine atom, or a chlorine atom, and n is an integer of 1 to 10), and an alkyl perfluorovinyl ether derivative represented by CF₂═CF—OCH₂—Rf² (wherein Rf² is a perfluoroalkyl group having 1 to 5 carbon atoms). In particular, at least one selected from the group consisting of PAVE, the vinyl monomer and the alkyl perfluorovinyl ether derivative is preferred, at least one selected from the group consisting of PAVE and HFP is more preferred, and PAVE is still more preferred.

As PAVE, perfluoro (alkyl vinyl ether) represented by CF₂═CF—ORf³ (wherein Rf³ represents a perfluoroalkyl group having 1 to 5 carbon atoms), is preferred. Examples thereof include perfluoro(methyl vinyl ether) [PMVE], perfluoro (ethyl vinyl ether) [PEVE], perfluoro (propyl vinyl ether) [PPVE], and perfluoro (butyl vinyl ether). In particular, at least one selected from the group consisting of PMVE, PEVE and PPVE is more preferred and PPVE is still more preferred.

As the alkyl perfluorovinyl ether derivative, one of which Rf² is a perfluoroalkyl group having 1 to 3 carbon atoms is preferred, and CF₂═CF—OCH—CF₂CF₃ is more preferred.

The ratio of the CTFE unit to the TFE unit in the polymer (b) is preferably 15 to 90 mol % CTFE unit to 85 to 10 mol % TFE unit, more preferably 20 to 90 mol % CTFE unit to 80 to 10 mol % TFE unit. A copolymer including 15 to 25 mol % CTFE unit and 85 to 75 mol % TFE unit is also preferred.

As the polymer (b), one containing 90 to 99.9 mol % CTFE unit and THE unit in total and 0.1 to 10 mol % monomer (a) unit is preferred. With a content of monomer (a) unit of less than 0.1 mol %, moldability, environmental stress cracking resistance and fuel cracking resistance tend to be poor, while with a content of more than 10 mol %, fuel barrier properties, heat resistance and mechanical properties tend to be poor.

As the polymer (b), since the occurrence of cracks in the inner layer may be further suppressed, and hydrochloric acid permeation may be further suppressed, a CTFE/TFE/PAVE copolymer is particularly preferred.

In the CTFE/TFE/PAVE copolymer, examples of the PAVE include perfluoro(methyl vinyl ether) [PMVE], perfluoro(ethyl vinyl ether) [PEVE], perfluoro(propyl vinyl ether) [PPVE], and perfluoro (butyl vinyl ether). In particular, at least one selected from the group consisting of PMVE, PEVE and PPVE is preferred, and PPVE is more preferred.

In the CTFE/TFE/PAVE copolymer, the content of the PAVE unit relative to the whole monomer units is preferably 0.5 mol % or more, and preferably 5 mol % or less. The content (mol %) of each monomer in the CTFE/TFE/PAVE copolymer is preferably (15.0 to 24.9)/(75.0 to 84.9)/(0.1 to 10.0), and more preferably (15.0 to 24.9)/(75.0 to 84.9)/(0.1 to 3.0).

The melting point of the polymer (b) is not limited, and is preferably 160 to 270° C.

The melting point of the polymer (b) is the temperature corresponding to the maximum value in the heat-of-fusion curve when the temperature is raised at a rate of 10° C./min using a differential scanning calorimeter [DSC].

The polymer (b) is preferably a melt-fabricable fluororesin. The MFR of the polymer (b) is preferably 0.5 to 100 g/10 min, more preferably 1 g/10 min or more, still more preferably 2 g/10 min or more, and more preferably 50 g/10 min or less, still more preferably 40 g/10 min or less.

The MFR of the polymer (b) is measured in accordance with ASTM D1238, using a die having a diameter of 2.1 mm and a length of 8 mm, under a load of 5 kg at an optional temperature in the range of about 230 to 350° C., which is the forming temperature range for typical fluorine polymers, (for example at 297° C.). The measurement temperature of MFR of the CTFE/TFE/PAVE copolymer is 297° C.

To the outer layer (B), for example, various additives such as a filler having electric conductivity, a stabilizer such as thermal stabilizer, a reinforcing agent, a filler, a UV absorber, and a pigment may be added, within a range not damaging the purpose of the present disclosure.

### <Layer Structure of Tube>

The double layer tube of the present disclosure includes an inner layer (A) and an outer layer (B), and the outer layer (B) is directly bonded onto the inner layer (A). In the double layer tube of the present disclosure, the boundary between the respective contacting layers is not necessarily required to be clear, and the molecular chains of the polymers that constitute the respective layers may mutually intrude from the contact surface to make a layer structure having a concentration gradient.

In the double layer tube of the present disclosure, the ratio between the thickness of the inner layer (A) and the thickness of the outer layer (B), ((A)/(B)), is 30.0/70.0 to 67.0/33.0. With a too small ratio ((A)/(B)), in the case where the tube with hydrochloric acid aqueous solution encapsulated therein is left standing in warm water for a long period, cracks tend to occur in the inner layer or low permeability of hydrochloric acid is not maintained. With a too large ratio ((A)/(B)), hydrochloric acid permeation cannot be sufficiently suppressed.

Since the occurrence of cracks in the inner layer may be further suppressed and hydrochloric acid permeation may be further suppressed, the ratio between the thickness of the inner layer (A) and the thickness of the outer layer (B), ((A)/(B)), is preferably 50.0/50.0 or more, and more preferably 60.0/40.0 or more. A larger ratio ((A)/(B)) is advantageous in welding the double layer tube of the present disclosure to another member such as a joint easily, and in enhancing the mechanical strength of a welded part.

The thickness of the double layer tube of the present disclosure, i.e., the total thickness of the inner layer (A) and the outer layer (B), is preferably 1.3 mm or more, more preferably 1.5 mm or more, and preferably 10.0 mm or less, more preferably 5.0 mm or less, still more preferably 2.0 mm or less. The thickness of the double layer tube of the present disclosure may be about 1.6 mm (for example, 1.56 to 1.64 mm). The double layer tube of the present disclosure may be a ¾-inch tube, or a ½-inch tube.

The double layer tube of the present disclosure according to an embodiment is characterized by having no cracks with a length of 10 μm or more in the inner layer (A), when the tube is encapsulated with an aqueous acid solution containing at least one acid selected from the group consisting of hydrochloric acid, hydrofluoric acid, nitric acid and sulfuric acid and left standing at room temperature for 150 days or more. The presence or absence of cracks can be determined through observation of the cross section of the double layer tube using a microscope.

The double layer tube of the present disclosure according to an embodiment is characterized by absence of cracks with a length of 10 μm or more in the inner layer (A), when the tube is encapsulated with 35 mass % chloric acid and left standing in warm water at 80° C. for 90 hours. The presence or absence of the cracks can be determined through observation of the cross section of the double layer tube using a microscope.

The double layer tube of the present disclosure can be produced by, for example, a production method comprising heat-treating a copolymer (a) with sprayed hot wind at 200 to 280° C. for 6 hours or more, and then stacking the resulting copolymer (a) and a polymer (b) to obtain a double layer tube.

The temperature of the hot wind is preferably 230° C. or more, more preferably 250° C. or more, and preferably 270° C. or less, more preferably 260° C. or less. With a too low temperature of the hot wind, high-temperature volatile substances cannot be sufficiently removed from the copolymer (a). With a too high temperature of the hot wind, the copolymer (a) may fuse to cause a lump, and in the case of using a pellet of the copolymer (a) in the heat treatment, the pellet may cause deformation.

The time period of spraying hot wind is 6 hours or more, preferably 8 hours or more, and preferably 30 hours or less, more preferably 20 hours or less, still more preferably 15 hours or less. By continuously spraying hot wind, removal of the high-temperature volatile substances from the copolymer (a) can be facilitated. Although the copolymer (a) is melted by heating in forming of the copolymer (a), sufficient removal of high-temperature volatile substances from the copolymer (a) cannot be achieved by the short-time heating in forming.

The hot wind after contact with the copolymer (a) may include high-temperature volatile substances. In order to facilitate removal of high-temperature volatile substances from the copolymer (a), it is preferable that hot wind be sprayed to the copolymer (a) while exhausting a part or the whole of the hot wind after contact with the copolymer (a). In the case where the hot wind sprayed to the copolymer (a) is circulated to be sprayed to the copolymer (a) again, or in the case where the copolymer (a) is contacted with a high-temperature gas in a sealed system, removal of high-temperature volatile substances is not facilitated, so that the rate of decrease in weight of the copolymer (a) may not be controlled in the range described above.

As the treatment method of the copolymer (a), a fluorination treatment for reducing the number of functional groups of the copolymer (a) is known. The fluorination treatment is performed by contacting a highly reactive fluorinating agent with the copolymer (a) in a sealed container, so that the rate of decrease in weight of the copolymer (a) cannot be controlled in the range described above, even when the fluorination treatment is performed at high temperatures for a long period.

As the hot wind, heated air, heated inert gas, or the like may be used. Although harder spraying of hot wind facilitates removal of high-temperature volatile substances from the copolymer (a), the air flow is limited not to cause scattering of the copolymer (a).

The form of the copolymer (a) to which the hot wind is sprayed may be in a form of powder, pellet or the like, though not limited. Since the copolymer (a) in a form of powder highly likely scatters in the hot wind, the copolymer (a) is preferably in a pellet form.

Examples of the method for stacking the copolymer (a) and the polymer (b) include:
a method of co-extrusion forming the copolymer (a) and the polymer (b) to make thermally fusion bonding (melt bonding) between the layers;
a method of making a layer containing the copolymer (a) and a layer containing the polymer (b) by an extruder separately, overlaying the respective layers, and making interlayer adhesion by thermally fusion bonding;
a method of making a single layer tube containing the copolymer (a), and extruding the polymer (b) onto the single layer tube by an extruder; and
a method of making a single layer tube containing the copolymer (a), electrostatically coating the surface of the single layer tube with the polymer (b), and then thermally melting the polymer (b) by heating the resulting coated product as a whole or by heating from the coating side.

Examples of the co-extrusion forming include conventionally known multi-layer co-extrusion forming method such as multi-manifold method and field block method.

The double layer tube of the present disclosure can be suitably used as a chemical solution piping tube for circulating a chemical solution, and particularly suitably used as a chemical solution piping tube for transporting a high-purity chemical solution for producing semiconductor devices. The double layer tube of the present disclosure allows cracks to hardly occur in the inner layer, so that low chemical solution permeability can be maintained for a long period to lower the replacement frequency in comparison with a conventional double layer tube.

The double layer tube of the present disclosure is preferably a chemical solution piping tube for circulating a chemical solution. Examples of the chemical solution include a chemical solution for producing semiconductors, such as ammonia water, ozone water, hydrogen peroxide water, hydrochloric acid, sulfuric acid, resist liquid, thinner liquid, and developer. As the chemical solution, an aqueous acid solution containing at least one acid selected from the group consisting of hydrochloric acid, hydrofluoric acid, nitric acid and sulfuric acid is preferred. The double layer tube of the present disclosure is able to suppress acid permeation even in such an aqueous acid solution for a long period.

The double layer tube of the present disclosure may be used, for example, as a tube for use in a semiconductor production facility or a semiconductor production apparatus such as a chemical solution supply line for semiconductor production, a chemical solution supply facility for semiconductor production, a semiconductor cleaning apparatus, and a coater developer.

Also, the double layer tube of the present disclosure is preferably used in a low humidity environment. By using the double layer tube in a low humidity environment, the occurrence of cracks in the inner layer may be further suppressed, and hydrochloric acid permeation may be further suppressed. The humidity in the usage environment is preferably 60% or less, and more preferably 30% or less.

While the embodiments has been described in the above, it will be understood that various changes in the embodiment and details may be made without departing from the subject matter and scope of the claims.
<1> According to a first viewpoint of the present disclosure:
provided is a double layer tube comprising an inner layer (A) and an outer layer (B) disposed directly on the inner layer (A),
wherein the inner layer (A) comprises a copolymer (a) that comprises tetrafluoroethylene unit and perfluoro (propyl vinyl ether) unit, and
the outer layer (B) comprises a polymer (b) that comprises at least chlorotrifluoroethylene unit;
wherein the copolymer (a) has a rate of decrease in weight of 0.05 mass % or less after heat treatment at 380° C. for 1 hour; and
wherein a ratio between a thickness of the inner layer (A) and a thickness of the outer layer (B), ((A)/(B)), is 30.0/70.0 to 67.0/33.0.
<2> According to a second viewpoint of the present disclosure:
provided is the double layer tube according to the first viewpoint, wherein a total thickness of the inner layer (A) and the outer layer (B) is 1.3 mm or more.
<3> According to a third viewpoint of the present disclosure:
provided is the double layer tube according to the first or second viewpoint, wherein a total thickness of the inner layer (A) and the outer layer (B) is 1.6 mm.
<4> According to a fourth viewpoint of the present disclosure:
provided is the double layer tube according to any one of the first to third viewpoints, wherein the copolymer (a) has a content of perfluoro (propyl vinyl ether) unit of 4.0 to 6.5 mass % relative to whole of monomer units constituting the copolymer (a).
<5> According to a fifth viewpoint of the present disclosure:
provided is the double layer tube according to any one of the first to fourth viewpoints, wherein the copolymer (a) has a melting point of 295 to 308° C.
<6> According to a sixth viewpoint of the present disclosure:
provided is the double layer tube according to any one of the first to fifth viewpoints, wherein the polymer (b) is a copolymer containing chlorotrifluoroethylene unit, a tetrafluoroethylene unit, and a monomer (α) unit derived from a monomer (α) copolymerizable with chlorotrifluoroethylene unit and the tetrafluoroethylene unit.
<7> According to a seventh viewpoint of the present disclosure:
provided is the double layer tube according to any one of the first to sixth viewpoints, wherein the polymer (b) is a copolymer comprising chlorotrifluoroethylene unit, tetrafluoroethylene unit, and a perfluoro(alkyl vinyl ether) unit.
<8> According to an eighth viewpoint of the present disclosure:
provided is the double layer tube according to any one of the first to seventh viewpoints, wherein the copolymer (a) has a zero shear viscosity of 2.00×10⁴ Pa·S or more.
<9> According to a nineth viewpoint of the present disclosure:
provided is the double layer tube according to any one of the first to eighth viewpoints, wherein the copolymer (a) has an MIT value of 2,600,000 times or more.
<10> According to a tenth viewpoint of the present disclosure:
provided is the double layer tube according to any one of the first to nineth viewpoints, wherein the inner layer (A) has no cracks with a length of 10 μm or more, when the tube is encapsulated with an aqueous acid solution containing at least one acid selected from the group consisting of hydrochloric acid, hydrofluoric acid, nitric acid and sulfuric acid and left standing at room temperature for 150 days or more.
<11> According to an eleventh viewpoint of the present disclosure:
provided is the double layer tube according to any one of the first to tenth viewpoints, wherein the inner layer (A) has no cracks with a length of 10 μm or more, when the tube is encapsulated with 35 mass % hydrochloric acid and left standing in warm water at 80° C. for 90 hours.
<12> According to a twelfth viewpoint of the present disclosure:
provided is the double layer tube according to any one of the first to eleventh viewpoints, wherein the copolymer (a) comprises tetrafluoroethylene unit and perfluoro (propyl vinyl ether) unit, as well as an other monomer unit derived from a monomer copolymerizable with tetrafluoroethylene and perfluoro (propyl vinyl ether),
wherein the copolymer (a) has a content of perfluoro (propyl vinyl ether) unit of 4.0 to 6.5 mass % relative to whole of monomer units constituting the copolymer (a), a content of tetrafluoroethylene unit of 93.5 to 96.0 mass % relative to whole of monomer units constituting the copolymer (a), and a content of the other monomer unit of 0 to 1.5 mass % relative to whole of monomer units constituting the copolymer (a);
wherein the copolymer (b) is a copolymer comprising chlorotrifluoroethylene unit, tetrafluoroethylene unit and a perfluoro (alkyl vinyl ether) unit, with a content (mol %) of each monomer (chlorotrifluoroethylene unit/tetrafluoroethylene unit/perfluoro (alkyl vinyl ether) unit) of (15.0 to 24.9)/(75.0 to 84.9)/(0.1 to 10.0);
wherein a total thickness of the inner layer (A) and the outer layer (B) is 1.56 to 1.64 mm; and
wherein a ratio between the thickness of the inner layer (A) and a thickness of the outer layer (B), ((A)/(B)), is 60.0/40.0 to 67.0/33.0.
<13> According to a thirteenth viewpoint of the present disclosure:
provided is a production method of the double layer tube according to any one of the first to twelfth viewpoints, comprising:
heat-treating the copolymer (a) with sprayed hot wind at 200 to 280° C. for 6 hours or more, and then stacking the resulting copolymer (a) and the polymer (b) to obtain the double layer tube.

### EXAMPLES

The embodiments of the present disclosure are described with reference to Examples as follows, though the present disclosure is not limited thereto.

The numerical values in Examples were measured by the following methods, respectively.

### (Compositional Features of Polymer)

The measurement was performed by 19F-NMR method.

### (Melt Flow Rate (MFR))

According to ASTM D1238, using a melt indexer (manufactured by Yasuda Seiki Seisakusho, Ltd.), the mass of the copolymer flowing out per 10 minutes (g/10 min) from a nozzle having an inner diameter of 2.1 mm and a length of 8 mm under a load of 5 kg at 372° C. or 297° C. was determined.

### (Rate of Decrease in Weight)

An aluminum cup was heated at 380° C. for 30 minutes to remove volatile substances from the aluminum cup. About 10 g of a copolymer pellet was placed in the aluminum cup to accurately weigh the aluminum cup with the pellet. The aluminum cup with the pellet was heated at 380° C. for 60 minutes. After heating, the aluminum cup with the pellet was weighed accurately. Based on the following formula, the rate of decrease in weight of the copolymer was determined.

$$Rate of decrease in weight ( mass \% ) = [ ( Weight before heating ) - ( Weight after heating ) ] / ( Weight before heating ) \times 100$$

$$( Zero shear viscosity )$$

The zero shear viscosity of the copolymer was measured by a melt viscoelasticity measurement apparatus MCR-302 manufactured by Anton Paar GmbH with a parallel plate as measurement jig attached thereto. The measurement temperature was 340° C. and the thickness of the sample was 1 mm. The frequency was swept from high frequency side to low frequency side, and the viscosity corresponding to a frequency of 0.1 rad/s was determined as zero shear viscosity.

### (MIT Value)

The MIT value of the copolymer was measured in accordance with ASTM D2176. Specifically, the copolymer was compression molded to make a test piece having a width of 12.7 mm, a length of 90 mm, and a thickness of 0.20 to 0.25 mm. The test piece was mounted on a MIT tester (model No. 12176 (manufactured by Yasuda Seiki Seisakusho, Ltd.)), and bent under conditions with a load of 1.25 kg, each of right and left folding angles of 135 degrees, number of times of folding of 175/min, so that the number of times until the test piece was cut off (MIT value) was measured.

### (Melting Point)

The melting point (2nd run) of each of the copolymers (a1) and (a2) was determined as temperature corresponding to the maximum value in the heat-of-fusion curve when the temperature was raised (2nd run) at a rate of 10° C./min using a differential scanning calorimeter [DSC].

The melting point of the polymers (b1) was determined as temperature corresponding to the maximum value in the heat-of-fusion curve when the temperature was raised at a rate of 10° C./min using a differential scanning calorimeter [DSC].

In Examples and Comparative Examples, the following materials were used.

### Copolymer (a1)

TFE/PPVE copolymer
TFE/PPVE (mass ratio): 96.5/3.5
MFR (372° C., 5 kg): 2.0 g/10 min
Rate of decrease in weight after heat treatment at 380° C. for 1 hour: 0.25 mass %
Zero shear viscosity (340° C.): 2.85×10⁴ Pa·S
MIT value: 800,000 times
Melting point: 308° C.

### Copolymer (a2)

TFE/PPVE copolymer
TFE/PPVE (mass ratio): 94.0/6.0
MFR (372° C., 5 kg): 1.6 g/10 min
Rate of decrease in weight after heat treatment at 380° C. for 1 hour: 0.05 mass %
Zero shear viscosity (340° C.): 3.32×10⁴ Pa·S
MIT value: 2,600,000 times
Melting point: 300° C.

The rate of decrease in weight of the copolymer (a2) was adjusted by the following method. On a tray, 1 to 3 kg of the pellet of TFE/PPVE copolymer having the compositional features and MFR described above were spread, and the tray was placed in a hot wind circulation-type electric furnace. While heating such that the temperature in the hot wind circulation-type electric furnace was 250° C., hot wind was allowed to pass through the heating furnace, so that the pellet on the tray was heat treated for 10 hours. In order to remove high-temperature volatile substances smoothly from the pellet, a part of the hot wind that had passed through the heating furnace was exhausted outside the heating furnace during the heat treatment.

### Polymer (b1)

TFE/CTFE/PPVE copolymer
TFE/CTFE/PPVE (mole ratio): 76.3/21.3/2.4
Melting point: 245° C.
MFR: 3 g/10 min (297° C., 5 kg)

### Comparative Example 1

Using the pellet of the copolymer (a1) and a tube-producing system, a ½-inch tube having an outer diameter of 12.70 mm and a thickness of 1.58 mm was produced.

### Comparative Example 2

A ½-inch tube was produced in the same manner as in Comparative Example 1, except that a copolymer (a2) was used instead of the copolymer (a1).

### Comparative Example 3

Using two types of double layer tube extruders with a multi-manifold mounted, the copolymer (a1) for the inner layer (A) and the polymer (b1) for the outer layer (B) were supplied to the two extruders, respectively, so that a ½-inch tube having an outer diameter of 12.70 mm and a thickness of 1.58 mm was produced. The thickness of the inner layer (A) was 1.05 mm and the thickness of the outer layer (B) was 0.53 mm.

### Example 1

A ½-inch tube was produced in the same manner as in Comparative Example 3, except that the copolymer (a2) was used instead of the copolymer (a1).

### (Evaluation of Tubes)

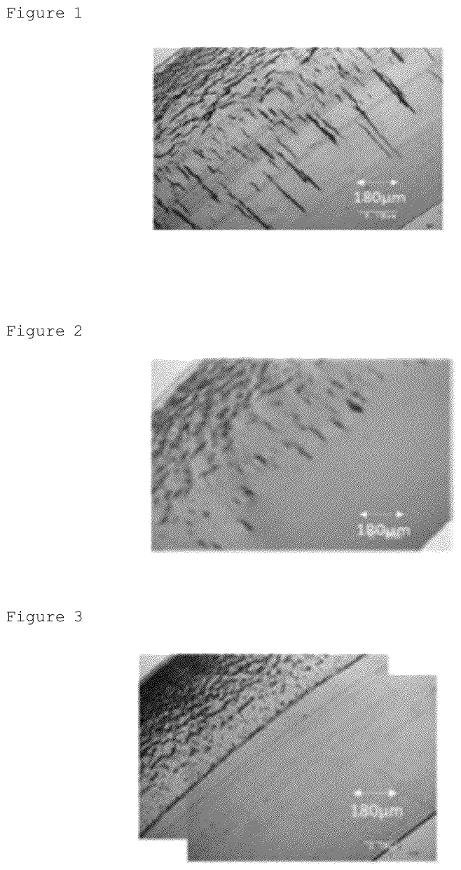

In the tubes made in Comparative Examples 1 to 2 and Example 1, 35 mass % hydrochloric acid was encapsulated, and the tubes were left standing in warm water at 80° C. for 90 hours. The tubes were collected from the warm water to observe the cross section of the tubes using a digital microscope. The images of the cross section of the tubes are shown in FIGS. 1 to 3.

From the image of the cross section of the tube shown in FIG. 3, it can be seen that the tube having an inner layer formed from the copolymer (a) with a rate of decrease in weight appropriately adjusted had no occurrence of cracks in the inner layer. On the other hand, from the images of the cross sections of the tubes shown in FIGS. 1 to 2, it can be seen that the single layer tube had innumerable occurrences of cracks having a length of 10 μm or more.

### (Measurement of 35% Hydrochloric Acid Permeation Coefficient)

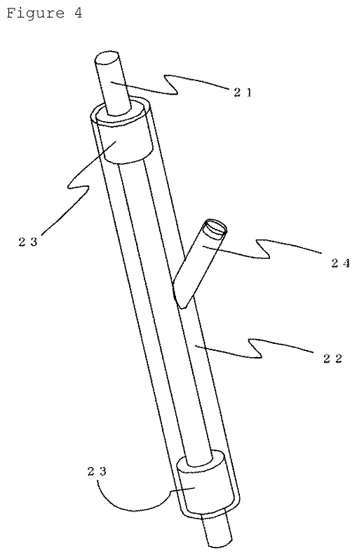

As shown in FIG. 4, one end of the tubes each produced in Comparative Example 3 and Example 1 was heat sealed, and 52 ml of 35 mass % hydrochloric acid was placed in a tube 21. Another end of the tube was also heat sealed. The tube 21 containing hydrochloric acid was inserted into a glass tube 22 and fixed with packings 23 made of fluoroelastomer. Subsequently, 110 ml of pure water was fed through a sampling port 24, and the glass tube was placed in a constant-temperature vessel at 25° C. On this occasion, the tube between the packings 23 was in contact with pure water, and the length of the part in contact with water was 18.5 cm. The glass tube was left standing as it is, and then about 1 ml was sampled through the sampling port 24 to quantitatively determine chlorine ion concentration Y (ppm) in the pure water using an ion chromatograph (product name: IC7000-E, manufactured by Yokogawa Electric Corporation). Using the following formula, the hydrochloric acid permeation coefficient (X) (ng·cm/cm²/days) was calculated.

$$Formula : X = [ ( β \times Film thickness ) / Cross sectional area ] / ( 8.64 \times 1 {0}^{7} )$$

β (unit: μg/s): slope of the tangent of permeation curve for 150 to 250 days (T=150 to 250) obtained by plotting α against T
α: total amount of permeation (unit: μg)=Y×W
Y: chlorine ion concentration (unit: ppm)
W: amount of pure water (unit: ml)
T: elapsed time from start of permeation (the time when hydrochloric acid was fed into double layer tube) to sampling (unit: s)
Film thickness: wall thickness of tube (unit: cm, 1.58 mm (0.158 cm))

Cross sectional area: area of part where the double layer tube was in contact with pure water (unit: cm²) in experimental equipment shown in FIG. 4

The tubes made in Comparative Example 3 and Example 1 had the following 35% hydrochloric acid permeation coefficients (150 to 250 days), respectively.
Comparative Example 3:20 ng·cm/cm²/days
Example 1: 7 ng·cm/cm²/days

1. A double layer tube comprising an inner layer (A) and an outer layer (B) disposed directly on the inner layer (A),
wherein the inner layer (A) comprises a copolymer (a) that comprises tetrafluoroethylene unit and perfluoro (propyl vinyl ether) unit, and
the outer layer (B) comprises a polymer (b) that comprises at least chlorotrifluoroethylene unit;
wherein the copolymer (a) has a rate of decrease in weight of 0.05 mass % or less after heat treatment at 380° C. for 1 hour; and
wherein a ratio between a thickness of the inner layer (A) and a thickness of the outer layer (B), ((A)/(B)), is 30.0/70.0 to 67.0/33.0.

2. The double layer tube according to claim 1,
wherein a total thickness of the inner layer (A) and the outer layer (B) is 1.3 mm or more.

3. The double layer tube according to claim 1,
wherein a total thickness of the inner layer (A) and the outer layer (B) is 1.56 to 1.64 mm.

4. The double layer tube according to claim 1, wherein the copolymer (a) has a content of perfluoro (propyl vinyl ether) unit of 4.0 to 6.5 mass % relative to whole of monomer units constituting the copolymer (a).

5. The double layer tube according to claim 1, wherein the copolymer (a) has a melting point of 295 to 308° C.

6. The double layer tube according to claim 1, wherein the polymer (b) is a copolymer comprising chlorotrifluoroethylene unit, tetrafluoroethylene unit, and a monomer (α) unit derived from a monomer (α) copolymerizable with chlorotrifluoroethylene unit and tetrafluoroethylene unit.

7. The double layer tube according to claim 1, wherein the polymer (b) is a copolymer comprising chlorotrifluoroethylene unit, tetrafluoroethylene unit, and a perfluoro (alkyl vinyl ether) unit.

8. The double layer tube according to claim 1, wherein the copolymer (a) has a zero shear viscosity of 2.00×10⁴ Pa·S or more.

9. The double layer tube according to claim 1, wherein the copolymer (a) has an MIT value of 2,600,000 times or more.

10. The double layer tube according to claim 1, wherein the inner layer (A) has no cracks with a length of 10 μm or more, when the tube is encapsulated with an aqueous acid solution containing at least one acid selected from the group consisting of hydrochloric acid, hydrofluoric acid, nitric acid and sulfuric acid and left standing at room temperature for 150 days or more.

11. The double layer tube according to claim 1, wherein the inner layer (A) has no cracks with a length of 10 μm or more, when the tube is encapsulated with 35 mass % hydrochloric acid and left standing in warm water at 80° C. for 90 hours.

12. The double layer tube according to claim 1,
wherein the copolymer (a) optionally comprises an other monomer unit derived from a monomer copolymerizable with tetrafluoroethylene and perfluoro (propyl vinyl ether),
wherein the copolymer (a) has a content of perfluoro (propyl vinyl ether) unit of 4.0 to 6.5 mass % relative to whole of monomer units constituting the copolymer (a), a content of tetrafluoroethylene unit of 93.5 to 96.0 mass % relative to whole of monomer units constituting the copolymer (a), and a content of the other monomer unit of 0 to 1.5 mass % relative to whole of monomer units constituting the copolymer (a);
wherein the copolymer (b) is a copolymer comprising chlorotrifluoroethylene unit, tetrafluoroethylene unit and a perfluoro (alkyl vinyl ether) unit, with a content (mol %) of each monomer (chlorotrifluoroethylene unit/tetrafluoroethylene unit/perfluoro (alkyl vinyl ether) unit) of (15.0 to 24.9)/(75.0 to 84.9)/(0.1 to 10.0);
wherein a total thickness of the inner layer (A) and the outer layer (B) is 1.56 to 1.64 mm; and
wherein a ratio between a thickness of the inner layer (A) and a thickness of the outer layer (B), ((A)/(B)), is 60.0/40.0 to 67.0/33.0.

13. A production method of the double layer tube according to claim 1, comprising:
heat-treating the copolymer (a) with sprayed hot wind at 200 to 280° C. for 6 hours or more, and then stacking the resulting copolymer (a) and the polymer (b) to obtain the double layer tube.
